(19) United States
(12) Patent Application Publication
(10) Pub. No.: US 2023/0029351 A1
(43) Pub. Date: Jan. 26, 2023

(54) ENERGY PRODUCTION AND STORAGE SYSTEM AND METHOD

(71) Applicant: Hans Gude GUDESEN, Gamle Fredrikstad (NO)

(72) Inventor: Hans Gude GUDESEN, Gamle Fredrikstad (NO)

(21) Appl. No.: 17/784,095

(22) PCT Filed: Dec. 14, 2020
(86) PCT No.: PCT/NO2020/050313

§ 371 Date: Jun. 9, 2022

(30) Foreign Application Priority Data
Dec. 16, 2019 (NO) 20191481

(51) Int. Cl. F03B 13/06; E02B 9/00

(52) U.S. Cl. CPC F03B 13/06; E02B 9/00

(57) ABSTRACT

A hydroelectric energy production and storage system comprising an upper reservoir located in a depression or cavity in the ground and a lower reservoir located underground, where objects are arranged in the depression or cavity forming an aggregate which fills the depression or cavity and comprises hydraulically communicating void volumes between the objects is disclosed. Further, a method for building and operating such a system is presented.

### FIELD OF THE INVENTION

The present invention relates to a system and a method for generating and storing hydroelectric energy.

### BACKGROUND OF THE INVENTION

The concept of underground pumped hydro energy storage (UPHS) is known in the Prior Art. It is conceptually similar to aboveground pumped hydropower where energy is stored by pumping water from a low-lying reservoir to a water reservoir at a higher elevation. When energy is needed, the water is returned to a turbine/generator combination at a lower level and dropped into the lower reservoir.

In underground pumped hydropower plants, the upper reservoir does not need to be located at high level aboveground, since water is delivered to the turbine at a level below the ground and collected in an underground cavity. This increases vastly the number of locations where pumped hydropower can be used, which is of particular interest in flat land regions and when operated in concert with renewable energy sources such as wind and sun. It also enables local communities to form electrical microgrid networks with increased autonomy and optimized energy trading solutions. A requirement for this is that the amount of water that can be stored in the upper and lower reservoirs is large enough. Depending on the elevation difference between the upper and the lower reservoirs, an energy storage capacity in the range 100 MWh-1 GWh shall imply a required water storage volume in the upper level reservoir to be 10⁴-10⁶ m³, corresponding to a pond or reservoir of surface area 10³-10⁵ m² at a water depth 10 m. The presence of such a body of water represents a problem in many cases, e.g in local communities with high population density, where microgrid storage appears especially attractive but where space is limited and concerns may be raised about safety and visual impact.

### Objects of the Present Invention

Accordingly, it is a major objective of the present invention to introduce novel concepts and techniques for underground pumped hydroelectric energy storage systems with the following characteristics:
Any negative environmental impact shall be negligible
The systems shall provide useful areas for local communities.
The above ground parts of the systems shall not represent a hazard for health or safety of people living nearby.

### Means for Solving the Problems

The objective is achieved according to the invention by a system and a method according to independent claims. A number of non-exhaustive embodiments, variants or alternatives of the invention are defined by the dependent claims.

### SUMMARY OF THE INVENTION

A first aspect of the invention is a hydroelectric energy production and storage system comprising an upper reservoir located in a depression or cavity in the ground, a lower reservoir comprising at least one cavity located underground at a lower altitude than the upper reservoir, a shaft extending from a low point of the upper reservoir to the lower reservoir for providing hydraulic connection between the upper and lower reservoir, energy production means comprising a turbine and generator unit arranged to be driven by water in the shaft, and energy storage means comprising pumping means arranged for pumping water from the lower reservoir to the upper reservoir. The system further comprises objects arranged in the depression or cavity forming an aggregate which fills the depression or cavity and comprises hydraulically communicating void volumes between the objects.

Optionally, the energy storage means comprise the turbine and generator unit run in reverse, or a separate pump.

Optionally, the depression or cavity is at least partially a landscape feature of natural origin. Further optionally, the depression or cavity is one of the following: A gully, valley, trench, pond or lake. Even further, the depression or cavity can be at least partially created by excavation or mining.

Optionally, the depression or cavity is one of the following: An open pit mine, tunnel opening, water reservoir, well, trench.

Optionally, the objects are made from incompressible materials. The objects can be of one or more of the following types: Rocks, gravel, sand. Further, the objects can be manufactured by molding, cutting, extrusion or crushing. Optionally, the objects are shaped as one or more of the following: Spheres, rods, pipes, symmetric or asymmetric polyhedra.

Optionally, the aggregate is arranged to present a defined upper surface. The upper surface can be covered by a membrane, and the membrane can be impermeable to gas or water or both. Optionally, the membrane is arranged and configured to collect gas transmitted to or from the aggregate of objects and guide it through a venting chimney to the ambient air.

Optionally, the aggregate contributes to constituting a landfill. The landfill can be providing real estate for one or more of the following: Buildings, industry, agriculture, gardens, leisure activities.

A further aspect of the invention is a method for building and operating a hydroelectric energy production and storage system as described above, comprising the steps of:
selecting, excavating or mining the depression or cavity;
excavating or mining a shaft extending into the ground from a low point of the depression or cavity;
excavating or mining at depth a cavity underground which communicates with the shaft;
positioning an electromechanical system comprising a turbine and generator unit at the bottom of the shaft, and connecting hydraulically the turbine to the top of the shaft;
providing a means for pumping water from the cavity underground to the level of the depression or cavity;
filling in partly or completely the depression or cavity with objects;
filling the system with a volume of water corresponding at a minimum to the volume of the underground cavity;
storing electrical energy by pumping water from the underground cavity to the void volume within the aggregate of objects; and
producing electrical energy by allowing water from the void volume within the aggregate of objects to flow down the shaft, to pass through the turbine and generator unit and to collect in the underground cavity.

Optionally, the objects arranged in the depression or cavity are at least in part rocks and gravel from the excavation or mining performed to create the system.

### DESCRIPTION OF THE DIAGRAMS

Embodiments of the present invention will now be described, by way of example only, with reference to the following diagrams wherein:

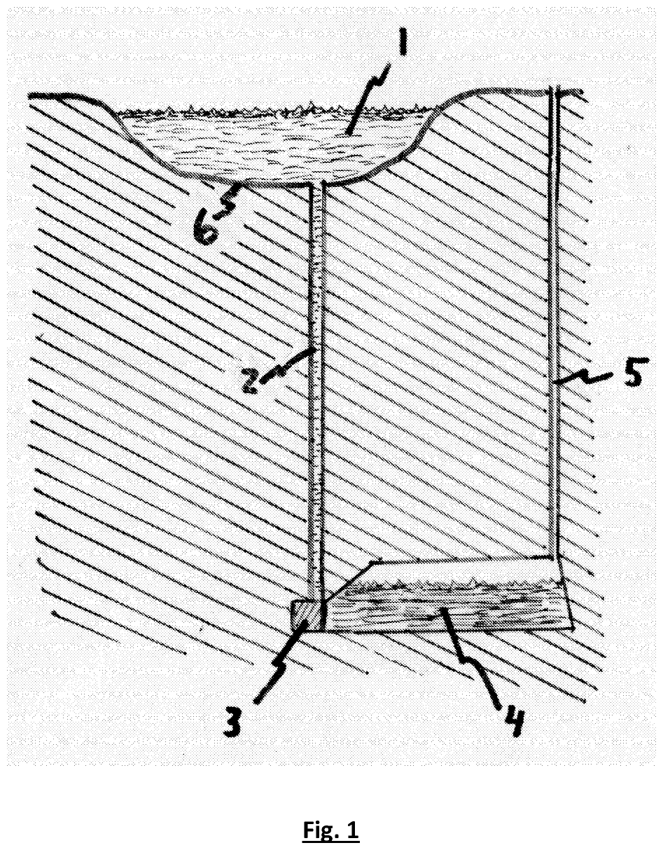

FIG. 1 shows a generic underground pumped hydro energy storage system (UPHS) according to prior art:

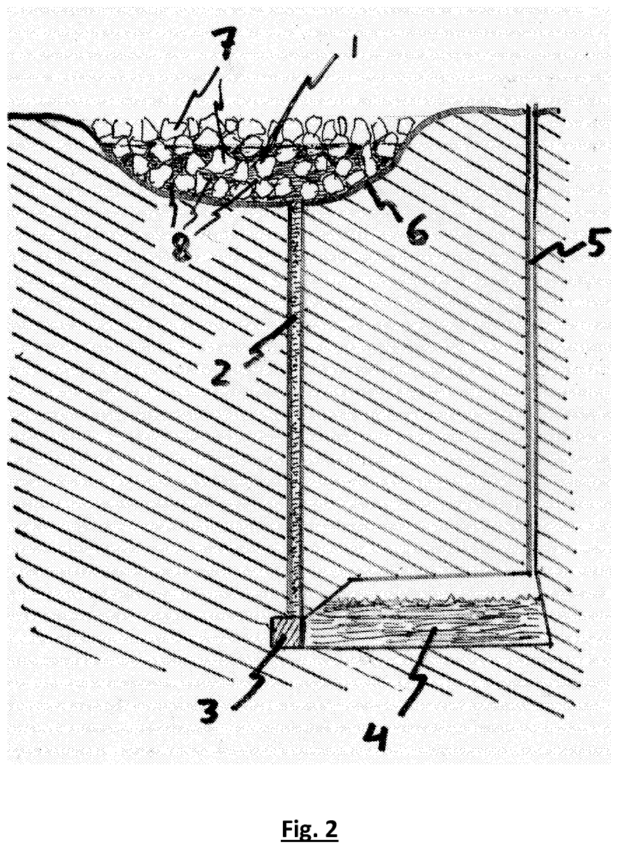

FIG. 2 discloses a generic version of the energy production and storage system according to the present invention.

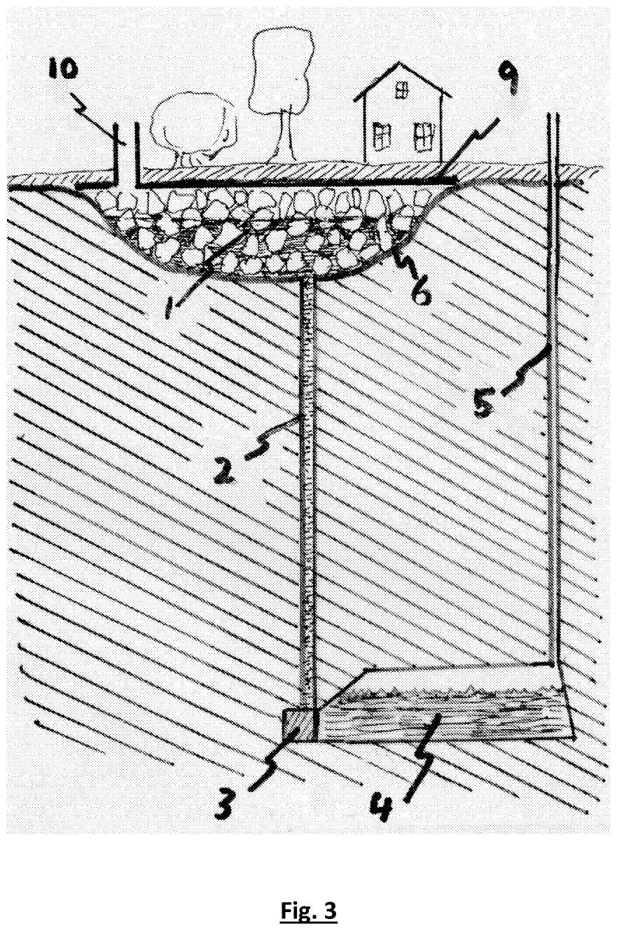

FIG. 3 shows an example of how the land surface area occupied by the upper reservoir has been reclaimed according to the present invention.

### LIST OF REFERENCE NUMBERS IN THE FIGURES

The following reference numbers refer to the drawings:

| Number | Designation |
|---|---|
| 1 | Upper reservoir |
| 2 | Shaft |
| 3 | Turbine/generator unit |
| 4 | Lower reservoir |
| 5 | Air shaft |
| 6 | Depression |
| 7 | Fill material |
| 8 | Void volume |
| 9 | Membrane |
| 10 | Venting chimney |

### DESCRIPTION OF PREFERRED EMBODIMENTS OF THE INVENTION

The following description of the exemplary embodiments refers to the accompanying drawings. The same reference numbers in different drawings identify the same or similar elements. The following detailed description does not limit the invention. Instead, the scope of the invention is defined by the appended claims. Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further particular features, structures or characteristics may be combined in any suitable manner or in one or more embodiments.

FIG. 1 shows an underground pumped hydro energy storage system (UPHS) according to prior art: Water is stored in an upper reservoir (1), which is shown in FIG. 1 in a depression (6) at or near the ground level. A shaft (2) extends into the ground from a low point of the upper reservoir (1). In periods when the UPHS delivers electricity (discharge cycle) water from the upper reservoir flows down the shaft (2) and drives a turbine/generator unit (3) located at the bottom of the shaft. Water from the turbine is collected by a lower reservoir (4) located at depth underground. In periods when the UPHS stores energy (charge cycle), the UPHS system receives electrical energy and pumps water from the lower to the upper reservoir. This may be achieved by different technical means; e.g. by running the turbine/generator unit (3) in reverse with the turbine now acting as a pump. An air shaft (5) connects the lower reservoir to ambient air, to avoid air pressure build-up in the lower reservoir when it fills with water.

The basic concept for the energy storage system according to the present invention is illustrated in FIG. 2: The system is similar to that shown in the prior art illustration FIG. 1, but now the upper reservoir (1) comprises a depression near or at the ground surface which is filled with fill material (7) shown as loose rocks or gravel here. In this case the volume available for storing water is the void volume (8) between the individual rock- or gravel particles which are packed in such a way that water can flow easily between them. The depression shown in FIG. 2 may be a natural feature (lake, pond, gully, valley). Alternatively, it may be excavated for this particular application, or it may be a feature of anthropogenic origin which no longer serves its original purpose. Examples of the latter are abandoned open pit mines and mine shafts, which often represent a negative impact on the local environment. Depending on local conditions, water in the upper reservoir may be prevented from leaking into the ground by natural rock surfaces on the bottom, or a membrane is positioned covering the bottom of the reservoir.

The arrangement shown in FIG. 2 provides some distinct advantages over prior art systems:
It allows the area occupied by the upper reservoir to be used for other purposes in addition to holding water. FIG. 3 shows an example of how the land surface area occupied by the upper reservoir has been reclaimed: A fill material, e.g. rocks and gravel, fills the depression to the top, which is covered by a membrane (9). The membrane prevents transport of material from the surface which could clog up and contaminate the fill material in the upper reservoir (1) and other parts of the energy storage system. During charging and discharging of the energy storage system, water rises and falls in the upper reservoir (1), forcing air to vent to the atmosphere through the fill material. The membrane guides this air to a venting chimney (10) as shown. Thus, valuable real estate can be created on land which may otherwise be considered worthless and even environmentally problematic.
During excavation of the shaft (2) and the lower reservoir (4) a great amount of rocks and gravel are brought to the surface. As an example, depending on depth and configuration, a system capable of storing 100 MWh energy shall require subterranean cavity volumes in the range 10⁴-10⁶ m³. Typically, this shall yield twice this volume in excavated rocks and gravel, which in many cases shall have to be transported elsewhere, representing a significant logistical and cost problem. By employing the excavated rocks and gravel to fill in the upper reservoir as taught in the present invention, all the excavated material is put to use at the site, without incurring the cost of transport to remote locations.

Assuming that the volumes of water that need to be stored in the upper and lower reservoirs are roughly equal, the minimum volume of rock and gravel that must be accommodated in the depression holding the upper reservoir shall correspond to that of the lower reservoir, plus an added volume which depends on the void space available to hold water between the individual rocks and gravel particles: If rock and gravel particles constitute a volumetric fraction q of the total rock and gravel volume Vₜₒₜₐₗ, the available void volume for storing water V_{void} interstitially is

V_{void}=(1−η)Vₜₒₜₐₗ. Eq. 1

Thus, for η=0.5, the void space is half the volume occupied by the rocks and gravel, and the minimum volume required for storage in the depression holding the rocks and gravel shall be roughly twice that of the lower reservoir.

The value of η depends on many factors, including the shape and size distribution of the rock and gravel particles, how they are packed, and the presence of earth, clay, sand and organic matter. As a general rule, the rock and gravel particles should be uniform, hard and clean (i.e. free from small particle fractions such as dust and sediments). Solid granite has a density of 2.69 tons/m³, which is reduced to 1.4-1.7 tons/m³ when in crushed or gravel form, corresponding to a volumetric void fraction (1-η)=0.36-0.48.

As shall be clear to a person skilled in the art, the basic principle taught in the present invention may allow any type of fill material that provides communicating internal voids and does not compress too easily. Thus, fill material can include objects of nearly any shape packed in organized or random fashion, either of natural origin (e.g. rocks, gravel) or manmade (e.g. spheres).

1. A hydroelectric energy production and storage system comprising:
an upper reservoir located in a depression or cavity in the ground;
a lower reservoir comprising at least one cavity located underground at a lower altitude than the upper reservoir;
a shaft extending from a low point of the upper reservoir to the lower reservoir for providing hydraulic connection between the upper and lower reservoir;
energy production means comprising a turbine and generator unit arranged to be driven by water in the shaft,
energy storage means comprising pumping means arranged for pumping water from the lower reservoir to the upper reservoir,
wherein
the system comprises objects arranged in the depression or cavity forming an aggregate which fills the depression or cavity and comprises hydraulically communicating void volumes between the objects.

2. The hydroelectric energy production and storage system according to claim 1, where the energy storage means comprise the turbine and generator unit run in reverse, or a separate pump.

3. The hydroelectric energy production and storage system according to claim 1, where the depression or cavity is at least partially a landscape feature of natural origin.

4. The hydroelectric energy production and storage system according to claim 3, where the depression or cavity is one of the following: gully, valley, trench, pond or lake.

5. The hydroelectric energy production and storage system according to claim 3, where the depression or cavity is at least partially created by excavation or mining.

6. The hydroelectric energy production and storage system according to claim 5, where the depression or cavity is one of the following: open pit mine, tunnel opening, water reservoir, well, trench.

7. The hydroelectric energy production and storage system according to claim 1, where the objects are made from incompressible materials.

8. The hydroelectric energy production and storage system according to claim 1, where the objects are of one or more of the following types: rocks, gravel, sand.

9. The hydroelectric energy production and storage system according to claim 1, where the objects are manufactured by molding, cutting, extrusion or crushing.

10. The hydroelectric energy production and storage system according to claim 9, where the objects are shaped as one or more of the following: spheres, rods, pipes, symmetric or asymmetric polyhedra.

11. The hydroelectric energy production and storage system according to claim 1, where the aggregate is arranged to present a defined upper surface.

12. The hydroelectric energy production and storage system according to claim 11, where the upper surface is covered by a membrane.

13. The hydroelectric energy production and storage system according to claim 12, where the membrane is impermeable to gas or water or both.

14. The hydroelectric energy production and storage system according to claim 12, where the membrane is arranged and configured to collect gas transmitted to or from the aggregate of objects and guide it through a venting chimney to the ambient air.

15. The hydroelectric energy production and storage system according to claim 1, where the aggregate contributes to constituting a landfill.

16. The hydroelectric energy production and storage system according to claim 15, where the landfill is providing real estate for one or more of the following: buildings, industry, agriculture, gardens, leisure activities.

17. A method for building and operating a hydroelectric energy production and storage system according to claim 1, comprising the steps of:
selecting, excavating or mining the depression or cavity;
excavating or mining a shaft extending into the ground from a low point of the depression or cavity;
excavating or mining at depth a cavity underground which communicates with the shaft;
positioning an electromechanical system comprising a turbine and generator unit at the bottom of the shaft, and connecting hydraulically the turbine to the top of the shaft;
providing a means for pumping water from the cavity underground to the level of the depression or cavity;
filling in partly or completely the depression or cavity with objects;
filling the system with a volume of water corresponding at a minimum to the volume of the underground cavity;
storing electrical energy by pumping water from the underground cavity to the void volume within the aggregate of objects; and
producing electrical energy by allowing water from the void volume within the aggregate of objects to flow down the shaft, to pass through the turbine and generator unit and to collect in the underground cavity.

18. The method for building and operating a hydroelectric energy production and storage system according to claim 17, where the objects arranged in the depression or cavity are at least in part rocks and gravel from the excavation or mining performed to create the system.

19. The hydroelectric energy production and storage system according to claim 2, where the depression or cavity is at least partially a landscape feature of natural origin.

20. The hydroelectric energy production and storage system according to claim 2, where the objects are made from incompressible materials.
